(19) United States
(12) Patent Application Publication
(10) Pub. No.: US 2020/0080678 A1
(43) Pub. Date: Mar. 12, 2020

(54) PIPELINE SYSTEM

(71) Applicant: Quest Automated Services, LLC, Tulsa, OK (US)

(72) Inventors: Hanz Da Silva, Fort Worth, TX (US); Edward Martell, Arlington, TX (US); Adam Cooper, Tulsa, OK (US)

(21) Appl. No.: 16/125,065

(22) Filed: Sep. 7, 2018

(51) Int. Cl. F16L 55/46; F16L 55/38; B08B 9/055; B08B 9/043

(52) U.S. Cl. CPC F16L 55/46; F16L 55/38; F16L 2101/12; B08B 9/0433; B08B 9/0553

(57) ABSTRACT

A pipeline system may have a pipeline that is connected to at least a pig selector with the pig selector concurrently housing multiple different pigs in separate pig chambers. A pig loader can be positioned proximal the pig selector and configured to load a pig from a pig chamber of the pig selector into a launch pipe connected to the pipeline.

### SUMMARY

A pipeline system, in some embodiments has a pipeline connected to a pig selector with the pig selector concurrently housing multiple different pigs in separate pig chambers. A pig loader is positioned proximal the pig selector and is configured to load a pig from a pig chamber of the pig selector into a launch pipe connected to the pipeline.

In accordance with other embodiments, a pipeline system has a controller connected to a pig selector, a pig loader, and at least one sensor with the pig selector housing a plurality of pigs is separate pig chambers. A launch pipe is connected to a pipeline and the pig loader is positioned to deploy a pig into the launch pipe from a pig chamber in accordance with a pigging strategy generated by the controller.

A pipeline system can be operated, in accordance with various embodiments, by detecting an operating condition of a pipeline with at least one sensor connected to a controller and generating a pigging strategy with the controller based on the detected operating condition. A first pig is selected from a pig selector in accordance with the pigging strategy and is subsequently deploy into a launch pipe with a pig loader to allow the first pig to be launched into the pipeline via the launch pipe.

### BRIEF DESCRIPTION OF THE DRAWINGS

FIG. 1 is a block representation of an example pipeline in which various embodiments may be practiced.

FIG. 2 conveys a cross-sectional line representation of portions of an example pipeline that can be utilized in some embodiments.

FIG. 3 displays portions of an example pipeline cleaning system that may be employed in the pipeline of FIGS. 1 & 2.

FIG. 4 depicts a block representation of an example slug that can be utilized in the cleaning system of FIG. 3 in accordance with various embodiments.

FIGS. 5A & 5B respectively represent portions of an example pigging system operated in accordance with some embodiments.

FIG. 6 shows portions of an example pig selector that can be utilized in a pigging system in some embodiments.

FIG. 7 depicts portions of an example pigging system configured in accordance with assorted embodiments.

FIG. 8 is a flowchart of an example pigging routine that can be carried out by the various embodiments of FIGS. 1-7.

### DETAILED DESCRIPTION

Continued hydrocarbon exploration has increased the demand for reliable and efficient oil and gas transportation. Hydrocarbon carrying pipeline, conduit, and tube, which can collectively be characterized as pipe, has the potential to provide adequate transportation performance as initially constructed. However, hydrocarbons transportation often degrades pipe over time due at least to the nature of the transported chemicals, the environmental conditions of the pipe, and the presence of debris. As a result, pipe maintenance is needed over time to maintain hydrocarbon transportation performance of a pipe as part of a pipeline.

Pipeline operation is critical to the overall hydrocarbon life cycle from exploration to refining. Hence, taking a pipeline offline to inspect and/or perform maintenance can result in delays and loss of productivity of downstream, and upstream, hydrocarbon processing centers. Accordingly, some pipe inspection equipment can be utilized while fluids flow. In yet, the use of such pipe inspection equipment can pose operational inefficiencies that degrade the overall performance of a pipeline.

With these issues in mind, various embodiments are directed to a pipeline system that utilizes intelligent pig selection and deployment means to send at least one pig through a pipe during fluid transportation within the pipe. The ability to select between multiple different pigging configurations allows a user to provide optimal pipe cleaning and inspection capabilities without delaying, or degrading, the flow of fluids, such as hydrocarbons, through the pipe. The generation of a pigging strategy based on at least one sensed pipeline condition allows a pipeline system to employ maximum inspection and cleaning effectiveness while maintaining pipe transportation performance.

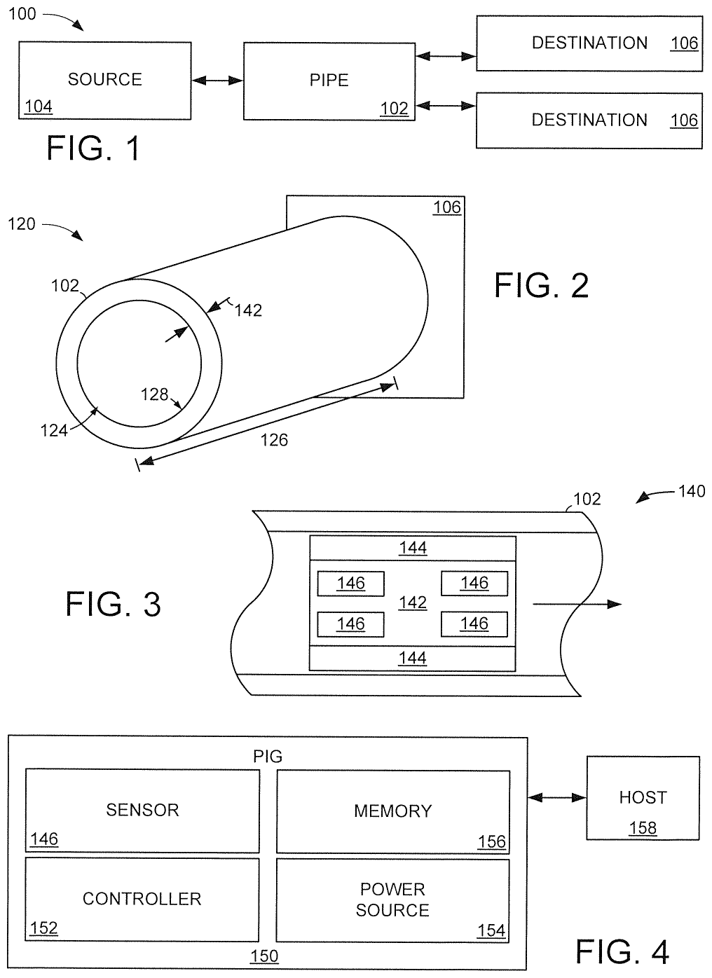

Turning to the drawings, FIG. 1 conveys a block representation of an example pipeline system 100 in which various embodiments may be practiced. A pipe 102 can continuously extend between one or more sources 104 to one or more destinations 106. It is contemplated that the pipe 102 can have one or more mechanical, or electronic, controls, such as valves, filters, pumps, compressors, dryers, and separators, that operate to allow fluids, such as liquids and gases, to travel continuously from a source 104 to a destination 106.

In a non-limiting embodiment, a source 104 is a hydrocarbon exploration site and a destination 106 is a hydrocarbon refining site. Other embodiments may have a source 104 as a pressure generator, such as a pump or compressor, and the destination 106 as a storage unit, such as a tank. It is contemplated that a plurality of separate sources 104 act concurrently, or sequentially, to send fluids to one or more separate destinations 106. Regardless of the number, type, and physical location of the source(s) 104 and destination(s) 106 of a pipeline system 100, the pipe 102 provides a continuous pathway for the fluid to flow. The pipe 102 may be sealed or unsealed with any number of control structure, such as valves and/or gates, that allow the path, pressure, and timing of fluid delivery to at least one destination 106.

FIG. 2 conveys a cross-sectional line representation of portions of an example pipeline 120 that can be utilized in the pipeline system 100 in some embodiments. The pipeline 120 consists of lengths of pipe 102 that are constructed with a uniform wall thickness 122. When the lengths of pipe 102 are connected to link at least one source to at least one destination, as shown in FIG. 1, the interior of the pipe 102 is open and relatively smooth to provide a consistent cross-sectional transport area 124 throughout the length 126 of the pipeline 120.

However, through use and changing environmental conditions over time, the interior transport area 124 can be altered in manners that degrade the fluid transportation performance of the pipeline 120. For instance and in no way limiting, transported fluids can physically alter the interior wall 128 of the pipe 102, which can create pressure differentials that degrade fluid transportation. Fluid being transported in the pipeline 120 can introduce debris that clog, and reduce, the transport area 124 of the pipeline 120 either temporarily when debris moves or long-term when the debris sticks to the interior pipe wall 128. It is noted that debris may be in the form of residual hydrocarbon chemicals, such as sludge, oils, paraffins, or combinations thereof. The blockage, or other alteration of the transport area 124, can be particularly detrimental to fluid transportation performance for the pipeline 120 in the aggregate along the pipeline length 126, such as over miles.

Accordingly, various embodiments engage in pipeline 120 cleaning operations that remove debris and other contaminants from the interior transport area 124. FIG. 3 displays portions of an example pipeline cleaning system 140 that can be utilized to clear portions of a pipeline, such as pipeline 120 of FIG. 2. The cleaning system 140 can physically position one or more slugs 142 into the transport area of a pipe with each slug sized to pass along the length of the pipe 102 under a predetermined pressure. It is contemplated that the slug(s) 142 can move along the pipe 102 with artificial pressure or with the pressure associated with flowing fluids.

The various slug(s) 142 can have physical features 144, such as flanges, cantilevered ridges, and/or brushes, that act on the interior wall of the pipe 102 to clear and/or clean the pipe 102 of debris and contaminants. The use of multiple different slugs 142 allows diverse cleaning capabilities that can efficiently reduce, or eliminate, the presence of contaminations that reduce the fluid transport area of the pipe 102. However, the manual selection, loading, and launching of various slugs 142 into a pipeline can be inefficient, particularly with respect to the fluid volume and pressure conditions within the pipeline. That is, manual time is needed to physically select and position one or more slugs 142 for pipeline insertion and the casual launching of a slug 142 during some fluid transport conditions, such as low pressure and/or volume intervals, can detrimentally impacts fluid transportation performance as well as slug 142 efficiency.

In some embodiments, a slug 142 can be configured with one or more sensors 146 that continuously, or sporadically, detect physical aspects of the pipe 102. For example, sensors 146 can measure pipe wall thickness, pipe joint integrity, and transport area to determine the current fluid transport status of at least a portion of a pipeline. The data from the sensor(s) 146 may additionally indicate what pipeline repairs are needed or what slug(s) 142 are needed to optimize the fluid transportation efficiency of the pipe 102.

FIG. 4 depicts a block representation of an example pig 150 that can be utilized in the cleaning system 140 of FIG. 3. The pig 150 has at least one sensor 146 that is connected to a local controller 152, power source 154, and memory 156 to allow data gathering capabilities while the pig 150 travels through a pipeline. Due to the enclosed and metallic configuration of a pipeline, the slug has difficulty transmitting data to a host 158. Thus, collected data is stored locally in the memory 156 and later retrieved by a host when the pig 150 is removed from the pipeline. The difficulty of a pig 150 to connect to a host 158 can result in a pig 150 being lost within a pipeline, which causes fluid transport performance losses as the pig 150 is retrieved.

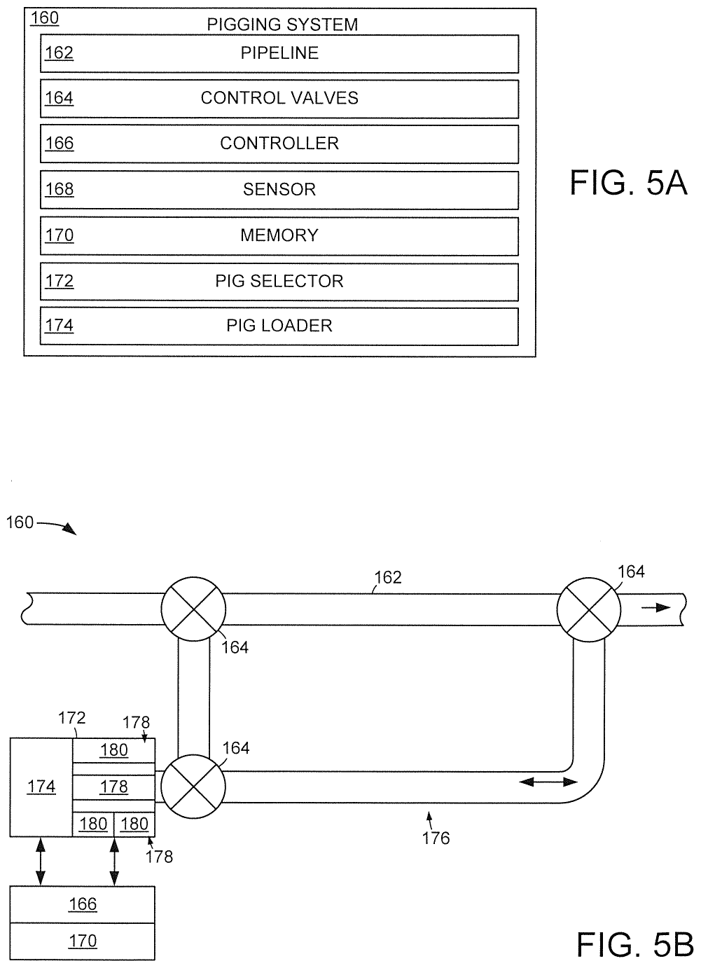

Hence, a pipeline system can be configured, in accordance with some embodiments, with optimized slug selection, distribution, and communication capabilities that increase the maintenance, and inspection, of fluid transporting pipelines. FIGS. 5A and 5B respectively represent portions of an example pigging system 160 that can be employed in a pipeline system to provide optimal sustained operation. The pigging system 160 connects to a pipeline 162 with one or more control valves 164 that provides for manipulation of the flow of fluid within the pipeline 162 to allow the introduction of one or more pigs, which can be similar to the slugs discussed in association with FIGS. 3 & 4, into the pipeline 162.

The pigging system 160 can employ one or more electronic controllers 166, such as a microprocessor or other programmable circuitry, to evaluate the pipeline 162 with at least one sensor 168, generate a pigging strategy stored in local memory 170, and carry out the pigging strategy with a pig selector 172 and a pig loader 174. The system sensors 168 may detect pipeline operation, such as fluid flow rate, volume, or pipe transport area, and environmental conditions, such as ambient temperature, humidity, and pressure, inside and/or outside the pipeline 162. The system controller 166 can utilize the detected operation and/or environmental conditions to determine what pigs are needed to increase fluid transport performance in the pipeline, which can be characterized as a pigging strategy.

The pigging strategy can be executed as directed by the controller 166 by manipulating the pig selector 172 to deliver one or more pigs to the pig loader 174 that physically positions each pig for launching into the pipeline 162. For instance, the pig selector 172 can provide two different types of pigs to the pig loader 174 so that each pig can be received by the control valves 164 and subsequently launched into the pipeline 162 by redirecting fluid flow. FIG. 5B depicts portions of an example pigging system 180 that utilizes the assorted aspects of the system 160 of FIG. 5A.

As shown in FIG. 5B, a pipeline 162 is accessed by a launch piping 176 via control valves 164 that allow pipeline fluid, and pressure, to be diverted to receive a pigging package 178 that consists of one or more pigs 180. The pigging package 178 conforms to a pigging strategy developed by the local controller 166 and is physically constructed by articulating the pig selector 172 relative to the pig loader 174 to move one or more selected pigs 180 into the launch piping 176. It is contemplated that multiple different selectors 172 and/or loaders 174 provide separate access to the launch piping 176 so that a plurality of pigging packages 178 can be concurrently positioned in the launch piping 176. The ability to connect multiple separate pig selectors 172 and loaders 174 to the launch piping 176 allows for efficient supply of different types of pigs 180 as well as optimized loading time for one or more pigging packages 178.

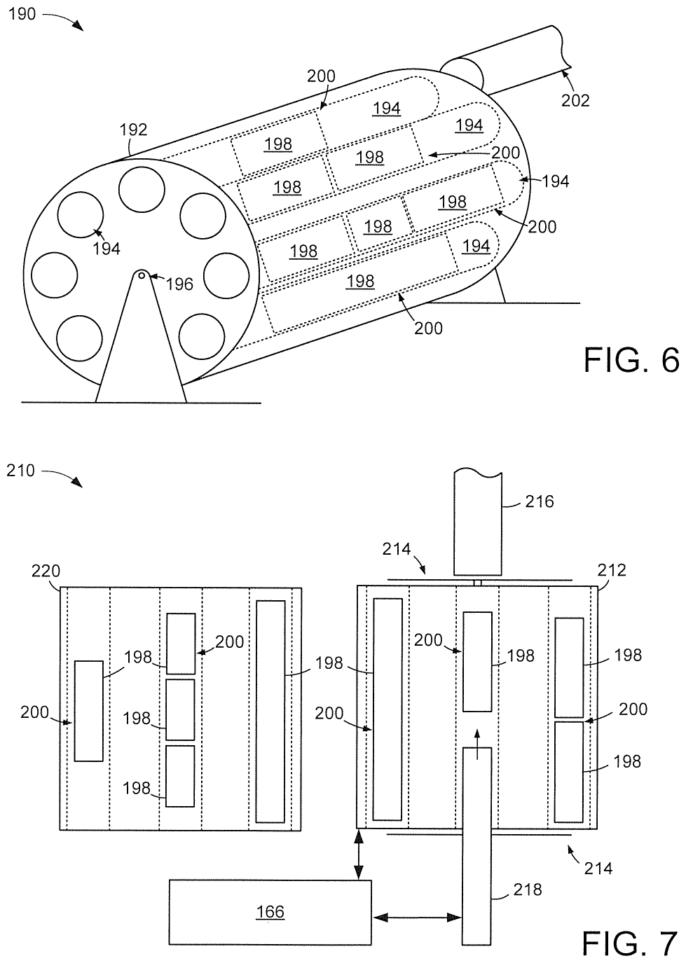

An example pig selector 190 is illustrated in FIG. 6, as configured in accordance with various embodiments to be employed in a pigging system. The pig selector 190 comprises a body 192 that can be a single piece of material or an assembly of multiple pieces. The body 192 can be any shape and size that provides multiple different pig chambers 194. In the non-limiting embodiment of FIG. 6, the body 192 has a cylindrical shape with a plurality of physically separate pig chambers 194 positioned about a central axis 196. Each pig chamber 194 continuously extends through the longitudinal extent of the body 192 and is configured to house one or more pigs 198, as shown in segmented lines.

The body 192 can be loaded with pigs 198 from one side by one or more pig loaders and retain the loaded pigs 198 until ejected from the opposite side of the body 192 into the launch piping of a pigging system. The concurrent storage of different pig packages 200 within the various pig chambers 194 allows the single body 192 to provide a diverse array of pigging options for a controller to generate, and execute, a pigging strategy. That is, different types of pigs 198 can be concurrently loaded into the pig chambers to form pig packages 200 that can be selected at will by a local controller to execute a pigging strategy.

By supporting the body 192 via the central axis 196, the body 192 can rotate to position a pig chamber 194 in alignment with launch piping 202 of a pigging system, such as piping 176. Alignment of a pig chamber 194 with launch piping can correspond with articulation of a loader, such as a mechanical arm, introduction of pressure, or other evacuation of the pig package 200 from the pig chamber 194. It is contemplated that the pig selector 190 and pig loader can be automated to provide relatively quick loading of one or more pig packages 200 into launch piping. Such pig package 200 delivery speed can contrast manual loading of individual pigs 198 into launch piping and provide optimized execution of pigging strategy that takes advantage of varying pipeline fluid transportation conditions.

While a pig selector body 192 can be loaded with one or more pig packages 200 at any time, some embodiments pre-load a body 192 with several different kinds of pigs 198, such as pigs of different sizes, uses, types, materials, and computing capabilities. The pre-loading of a selector body 192 allows different bodies 192 to be utilized at will. FIG. 7 depicts portions of an example pigging system 210 that employs different selector bodies 212 each pre-loaded with multiple pig packages 200 ready for deployment into a pipeline in accordance with a pigging strategy. As shown, a first pig selector body 212 is mounted on a stand 214 that allows for body rotation and deployment of a single pig package 200 into launch piping 216.

A local controller 166 can execute a pigging strategy by rotating the body 212 and deploying any number of pig packages 200 via articulation of a pig loader 218. At any time, the controller 166 may eject the mounted selector body 212 and load a different second body 220, which may be pre-loaded with pig packages that match, or differ, from the initial configuration of the first selector body 212. It is contemplated that the automated ejection and loading of different selector bodies 212/220 provides long-term pigging operation with minimal human interaction, which can be particularly beneficial in remote physical locations where hydrocarbon pipelines are prevalent. For instance, multiple different selector bodies 212/220 allows an empty body 212 to be replaced automatically without human interaction to seamlessly service one or more different pigging strategies developed by the local controller 166 over time.

It is contemplated that the non-mounted selector bodies 220 can be physically transported to the stand 214 via any mechanical, and/or pneumatic, transport system, such as a ramp, track, pick-and-place, crane, or conveyor. Body 212/220 loading, and ejecting, can be accomplished via gravity, in some embodiments, and/or by mechanical means that selectively move a body 212/220 into, and out of, attachment to a rotating mechanism of the stand 216. In alternative embodiments, a selector body can be a rack holding multiple different pig packages 200 that are mechanically transferred to the launch piping 216 via the pig loader 218 without rotating of the selector body.

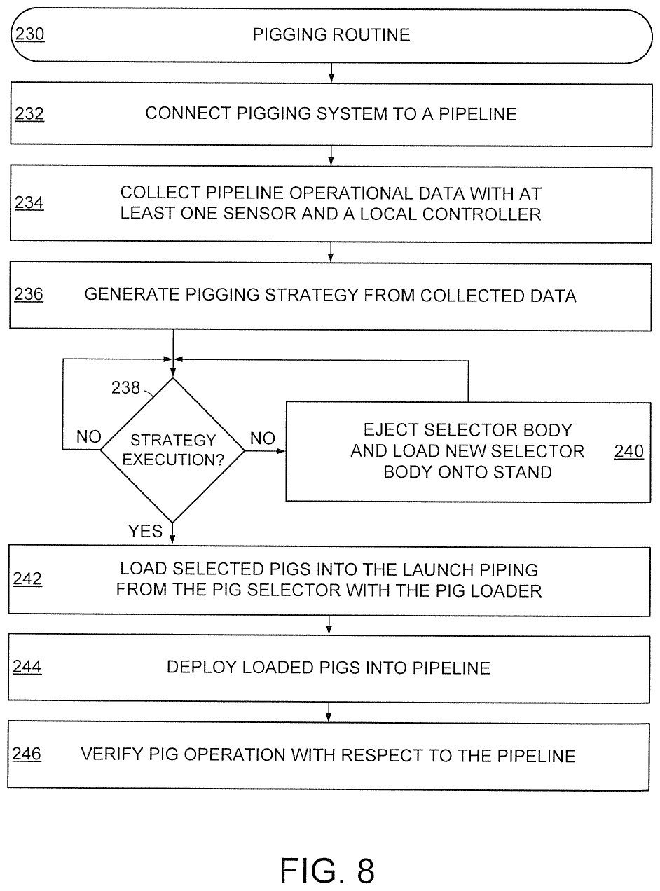

FIG. 8 is a flowchart of an example pigging routine 230 that can be conducted with the assorted embodiments of FIGS. 2-7 to provide optimized pipeline operation over time. At any time, step 232 connects a pigging system controller to a pipeline, which allows for the collection of pipeline operational data in step 234 via one or more sensors, such as mechanical, environmental, optical, or acoustic sensors. The collection of data in step 234 can be conducted continuously over time, sporadically at scheduled times, or in response to a detected trigger, such as interruption of hydrocarbon flow, pressure threshold being reached, or fluid temperature reaching a threshold. It is contemplated that a smart pig may be launched into the pipeline in step 234 to detect, and/or verify, pipeline operating conditions.

The collected operational data from a pipeline allows the local pigging system controller to generate one or more pigging strategies in step 236 that are directed to establishing, and/or maintaining, optimal pipeline fluid transport performance, such as volume flow, pressure flow, internal pipe turbulence, heat, and transport time. For example, a pigging strategy can be generated to correct a detected issue, such as pressure variations. As another example, a pigging strategy may call for proactive actions that clean, or inspect, portions of a pipeline.

The ability to efficiently select, deploy, and launch one or more pig packages with a pig selector and loader allows the generated pigging strategies to take advantage of relatively short operational intervals, such as high pressure events, high volume events, or hazardous hydrocarbon material transport, to reactively, and/or proactively alter the operating conditions with the constituent pig(s) of the pig packages. That is, different pigs with different shapes, sizes, materials, and weights can be quickly deployed by a rotating pig selector to carry out relatively complex pigging strategies in time to aid, reduce, or prevent future operational conditions, which would be nearly impossible with human selection, loading, and deployment of individual pigs.

A pigging strategy may additionally set pig package launch criteria, such as launch pressure and time to divert pipeline flow via control valves. The combination of pipeline operational conditions and launch conditions in a pigging strategy allows for sophisticated pipeline maintenance that ensures high fluid transport performance over time. The generation of at least one pigging strategy can prompt decision 238 to evaluate if strategy execution is appropriate. If no pigs are available for deployment, decision 238 can execute step 240 that ejects an empty, or insufficient, selector body and subsequently loads an alternate selector body to a stand that allows one or more pigs to be loaded into an adjacent launch piping.

At the conclusion of step 240, or if pipeline operating conditions called for by an active pigging strategy have not been met, decision 238 is revisited. At some point when operating conditions and available pig packages are available in accordance with a pigging strategy, step 242 loads the corresponding pig package(s) into a launch piping to allow step 244 to deploy the loaded package(s) into the pipeline with the launch characteristics (pressure, volume, time) prescribed by the pigging strategy.

It is contemplated that multiple different pigging strategies may be concurrently be evaluated by decision 238. In such a case, decision 238 may overcome conflicts between steps 240 and 242 by prompting the pigging controller to revise a previously generated strategy. For instance, replacement of an empty selector body may be prioritized in decision 238 by a local controller while an existing pigging strategy is amended to account for current pipeline operating conditions. While pig launching conditions may be missed with such strategy revision, accounting for current pipeline operating conditions allows for active pigging strategies to be relevant despite changes in environmental and/or operational conditions.

With the deployment of at least one pig in step 242 in accordance with a pigging strategy, some operational characteristics of a pipeline is at least temporarily altered, such as amount of pipe wall contaminants, operating pressure, operating volume. Step 246 can be conducted at any time after the deployment of a pig in step 242 to verify the completion, and effectiveness, of the execution of the pigging strategy. Such verification can trigger step 236 to be revisited and an active pigging strategy to be amended. Such verification can alternatively be logged by the local system controller to improve future pigging strategies, such as what types of pigs are effective during various hydrocarbon transport conditions. As a result of step 246, future pigging strategies can more effectively optimize pipeline operation.

What is claimed is:

1. An apparatus comprising a pipeline connected to a pig selector, the pig selector concurrently housing multiple different pigs in separate pig chambers, a pig loader positioned proximal the pig selector and configured to load a pig from a pig chamber of the pig selector into a launch pipe connected to the pipeline.

2. The apparatus of claim 1, wherein the pig selector comprises a cylindrical body with the separate pig chambers positioned about a central axis of the cylindrical body.

3. The apparatus of claim 2, wherein each pig chamber extends through the cylindrical body parallel to a longitudinal axis of the cylindrical body.

4. The apparatus of claim 2, wherein the pig selector is mounted in a stand configured to allow rotation of the cylindrical body about the central axis.

5. The apparatus of claim 1, wherein the launch pipe is connected to the pipeline via at least one control valve.

6. The apparatus of claim 1, wherein the pig loader is a mechanical arm positioned to extend into a selected pig chamber.

7. The apparatus of claim 1, wherein a pig chamber houses multiple different pigs.

8. The apparatus of claim 1, wherein a pig housed in a pig chamber is sized to pass through the pipeline in response to fluid moving through the pipeline.

9. The apparatus of claim 1, wherein each pig chamber houses at least one pig.

10. A system comprising:
a pipeline;
a controller connected to a pig selector, a pig loader, and at least one sensor, the pig selector housing a plurality of pigs is separate pig chambers; and
a launch pipe connected to the pipeline, the pig loader positioned to deploy a pig into the launch pipe from a pig chamber in accordance with a pigging strategy generated by the controller.

11. The system of claim 10, wherein the controller is connected to a plurality of different sensors positioned proximal the pipeline.

12. The system of claim 10, wherein the at east one sensor is an environmental sensor.

13. The system of claim 10, wherein the at least one sensor is configured to detect an operational condition within the pipeline.

14. The system of claim 10, wherein the launch pipe directs fluid from the pipeline into contact with the deployed pig.

15. A method comprising:
detecting an operating condition of a pipeline with at least one sensor connected to a controller;
generating a pigging strategy with the controller based on the detected operating condition;
selecting a first pig from a pig selector in accordance with the pigging strategy;
deploying the first pig into a launch pipe with a pig loader; and
launching the first pig into the pipeline via the launch pipe.

16. The method of claim 15, wherein the pigging strategy determines a type of pig to be selected from the pig selector.

17. The method of claim 15, wherein the controller rotates the pig selector to align a pig chamber housing the first pig with the pig loader and launch pipe.

18. The method of claim 15, wherein the pigging strategy selects a second pig from the pig selector to be deployed by the pig loader into the launch pipe.

19. The method of claim 18, wherein the second pig is deployed into the launch pipe and launched concurrently with the first pig.

20. The method of claim 15, wherein the controller ejects a first body of the pig selector and mounts a second body in the pig selector in response to the pigging strategy.
